(19) United States
(12) Patent Application Publication
(10) Pub. No.: US 2008/0147308 A1
(43) Pub. Date: Jun. 19, 2008

(54) Integrating Navigation Systems

(76) Inventors: Damian Howard, Winchester, MA (US); Douglas C. Moore, North Grafton, MA (US)

Correspondence Address: FISH & RICHARDSON PC, P.O. BOX 1022, MINNEAPOLIS, MN, 55440-1022, US

(21) Appl. No.: 11/612,003

(22) Filed: Dec. 18, 2006

(51) Int. Cl. G01C 21/00

(52) U.S. Cl. 701/200; 701/208; 340/995.1

(57) ABSTRACT

Vehicle data generated by circuitry of a vehicle is received and functions of a personal navigation device, which are otherwise used to process device navigational data that are generated by navigational circuitry in the personal navigation device, are used to process the vehicle data to produce output navigational information.

User interface commands and navigational data are communicated between a personal navigation device and a media head unit of a vehicle, the user interface commands and navigational data being associated with a device user interface of the device, and a vehicle navigation user interface at the media head unit displays navigational information and receives user input for control the display of the navigational information on the media head unit, the vehicle navigation user interface being coordinated with the user interface commands and navigational data associated with the device user interface.

### TECHNICAL FIELD

This disclosure relates to integrating navigation systems.

### BACKGROUND

In-vehicle entertainment systems and portable navigation systems sometimes include graphical displays, touch-screens, physical user-interface controls, and interactive or one-way voice interfaces. They may also be equipped with telecommunication interfaces including terrestrial or satellite radio, Bluetooth, GPS, and cellular voice and data technologies. Entertainment systems integrated into vehicles may have access to vehicle data, including speed and acceleration, navigation, and collision event data. Navigation systems may include databases of maps and travel information and software for computing driving directions. Navigation systems and entertainment systems may be integrated or may be separate components.

### SUMMARY

In general, in one aspect, current vehicle data generated by circuitry of a vehicle is received and functions of a personal navigation device, which are otherwise used to process device navigational data that are generated by navigational circuitry in the personal navigation device, are used to process the current vehicle data to produce output navigational information.

Implementations may include one or more of the following features. The current vehicle data includes data generated from wireless signals about the vehicle's location and received from a remote source. The current vehicle data about the vehicle's location has a relatively higher level of accuracy than the device navigational data. The current vehicle data includes location information generated by devices on the vehicle. The current vehicle data includes information characterizing motion of the vehicle. The current vehicle data includes data related to operation of the vehicle.

In general, in one aspect, a display location at which information may be displayed to an occupant of a vehicle is associated with a media head unit of the vehicle, and a display is generated at the display location based at least in part on navigational data or output navigational information provided by a personal navigation device.

Implementations may include one or more of the following features. The display location includes a place on the media head unit at which the personal navigation device can be mounted in an orientation that enables an occupant of the vehicle to view a display screen and manipulate controls of the personal navigation device. The display location includes a region of a display of the media head unit. The personal navigation device is separate from the media head unit. The display is generated based in part on navigational data or output navigational information provided by navigational circuitry of the vehicle. The display is generated based in part on data or information unrelated to navigation.

In general, in one aspect, a display is generated at a display location associated with a media head unit of a vehicle based in part on data provided by a personal navigation device separate from the media head unit, and in part on data generated by the media head unit.

Implementations may include one or more of the following features. The data provided by the personal navigation device includes a video image of a map. The data provided by the personal navigation device includes information describing a map. The data provided by the personal navigation device includes information usable by the media head unit to draw a map or display navigation directions based on images stored in a memory of the media head unit. The data generated by the media head unit includes information about a status of a media playback component. The data generated by the media head unit includes information about a two-way wireless communication. The data provided by the personal navigation device comprises information usable by the media head unit to display navigation status based on exchanged data.

In general, in one aspect, user interface commands and navigational data are communicated between a personal navigation device and a media head unit of a vehicle, the user interface commands and navigational data being associated with a device user interface of the device, and a vehicle navigation user interface at the media head unit that displays navigational information and receives user input to control the display of the navigational information on the media head unit, the vehicle navigation user interface being coordinated with the user interface commands and navigational data associated with the device user interface.

In general, in one aspect, a common communication interface between a media head unit of a vehicle and any one of several different brands of personal navigation device carries user interface command information, audio-related signals for navigational prompts, image-related signals for navigational displays, point of interest data, database search commands, and navigational-related data identifying current locations of the vehicle in a common format, and each of the different brands of personal navigation device internally use proprietary formats for at least some of the user interface command information, audio-related signals for navigational prompts, image-related signals for navigational displays, point of interest data, and navigational-related data identifying current locations of the vehicle.

In general, in one aspect, a personal navigation device includes navigational circuitry to generate device navigational data, an input for vehicle data, and a processor configured to process the device navigational data to perform navigational functions and output navigational information. The processor is also configured to process the vehicle data to perform the navigational functions and output the navigational information.

Implementations may include one or more of the following features. The input for vehicle data is configured to receive data generated from wireless signals about the vehicle's location received from a remote source. The input for vehicle data is configured to receive information generated by devices on the vehicle. The input for vehicle data is configured to receive information characterizing motion of the vehicle. The input for vehicle data is configured to receive data related to operation of the vehicle.

In general, in one aspect, a personal navigation device includes a processor for generating a video display of navigational information, an output for providing the video display to a separate device.

In general, in one aspect, a communications interface communicates user interface commands and navigational data associated with a device user interface of a personal navigation device between the personal navigation device and a media head unit. The media head unit has a vehicle navigation user interface including a display of navigational information and an input for receiving user input for control of the display. The vehicle navigation user interface is coordinated with the user interface commands and navigational data associated with the device user interface.

A media head unit of a vehicle receives data from a personal navigation device representing a user interface of the personal navigation device, generates a display for a user interface of the media head unit based on the received data, receives input commands through the user interface of the media head unit, and transmits the user interface commands to the personal navigation device.

The instructions may cause the media head unit to generate the display by combining graphical elements representing the user interface of the personal navigation device with graphical elements representing a status of components of the media head unit.

A personal navigation device having a user interface generates data representing a user interface of the device, transmits the data to a media head unit of a vehicle, receives input commands from the media head unit, and applies the input commands to the user interface of the device as if the commands were received through the user interface of the device.

A personal navigation device having a user interface receives vehicle data from circuitry of a vehicle and processes the vehicle data to produce output navigational information.

Implementations may include one or more of the following features. The instructions cause the device to process the vehicle data to identify a speed of the vehicle. The instructions cause the device to process the vehicle data to identify a direction of the vehicle. The instructions cause the device to process the vehicle data to identify a location of the vehicle. The instructions cause the device to process the vehicle data to identify a location of the vehicle based on a previously-known location of the vehicle and a speed and direction of the vehicle since a time when the previously known location was determined.

Other features and advantages of the invention will be apparent from the description and the claims.

### DESCRIPTION

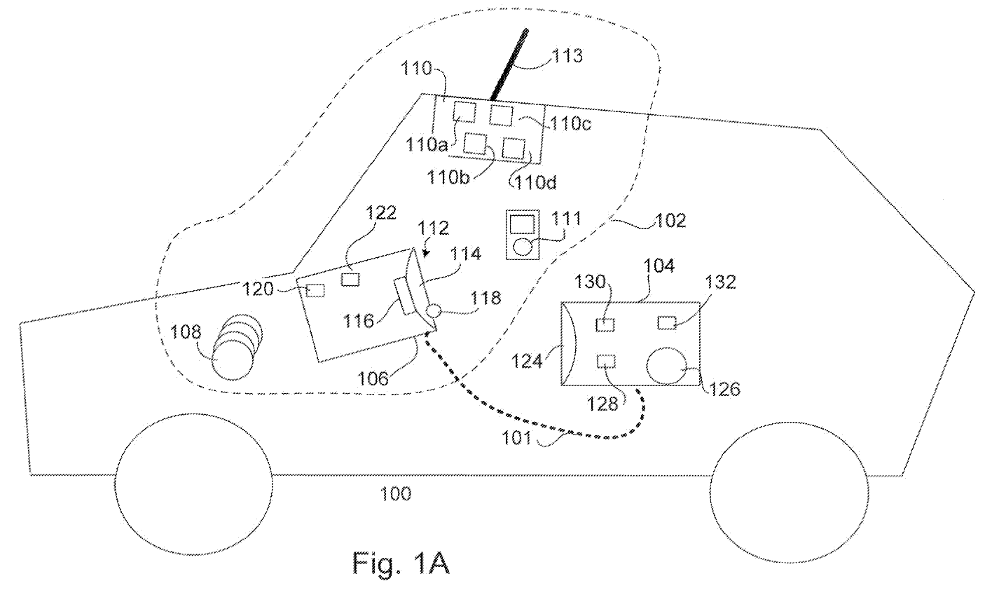

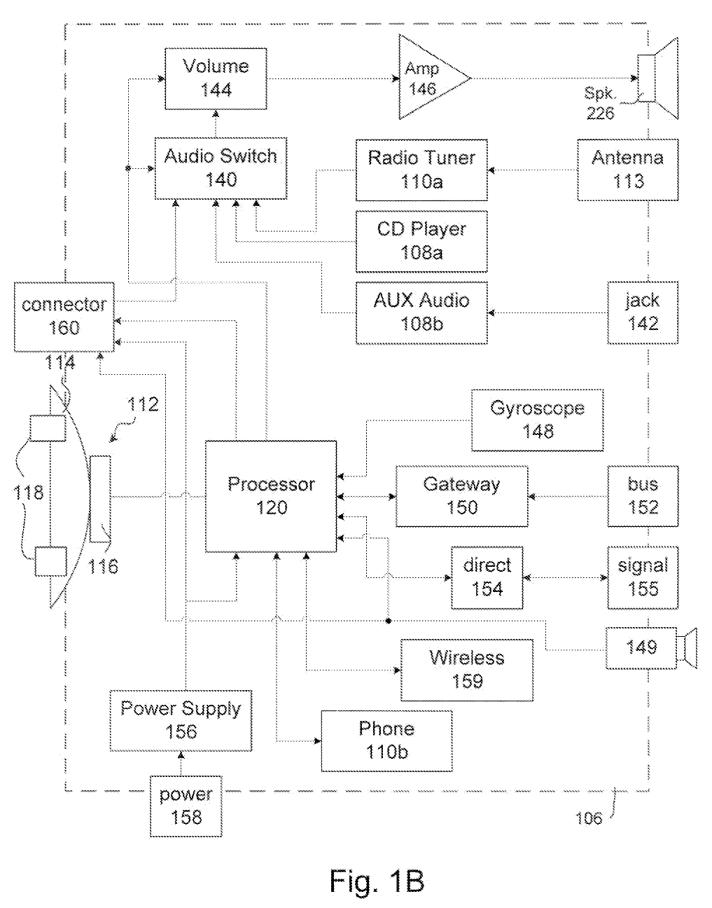

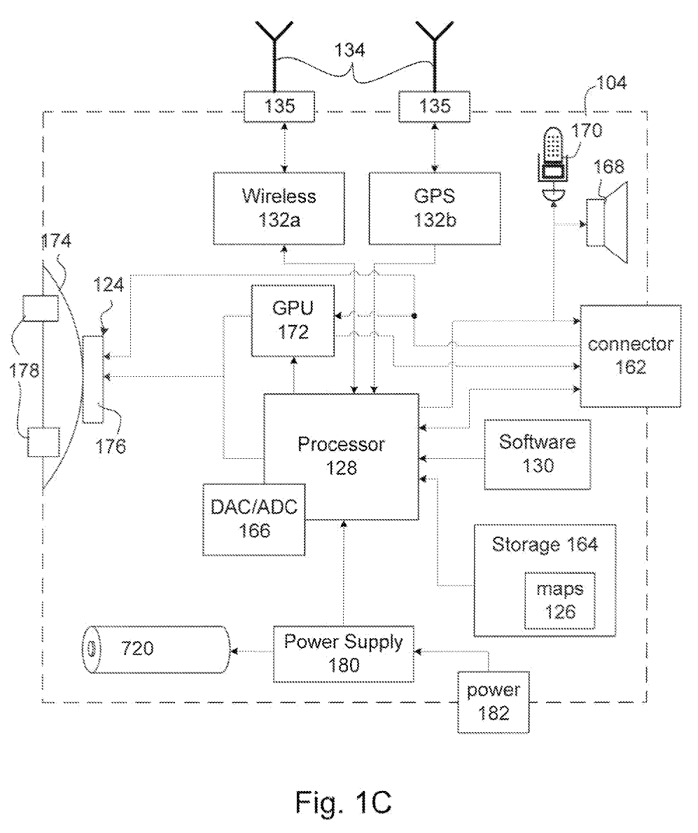

FIGS. 1A, 7, 8A-8B, and 9 are block diagrams of a vehicle information system.

FIG. 1B is a block diagram of a media head unit.

FIG. 1C is a block diagram of a portable navigation system.

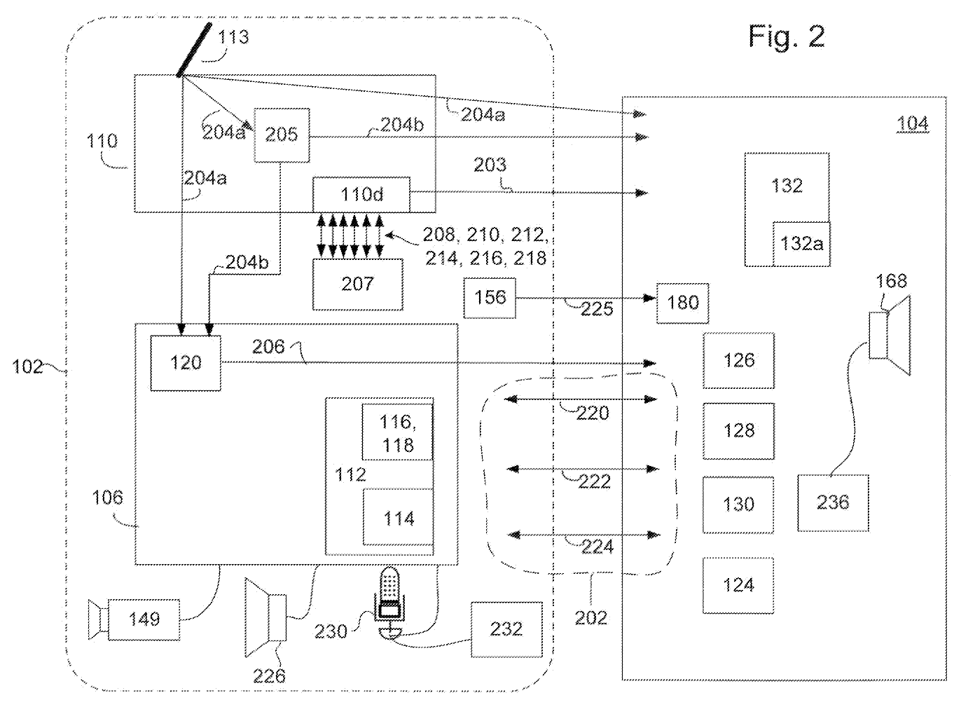

FIGS. 2, 5, 10, and 11 are block diagrams showing communication between a vehicle entertainment system and a portable navigation system.

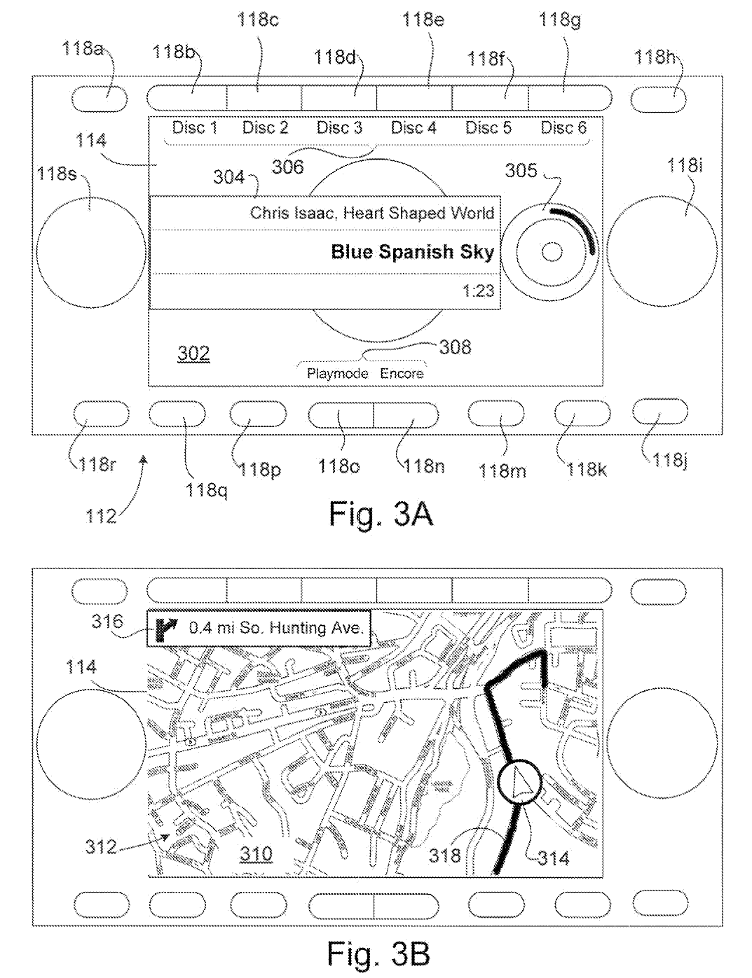

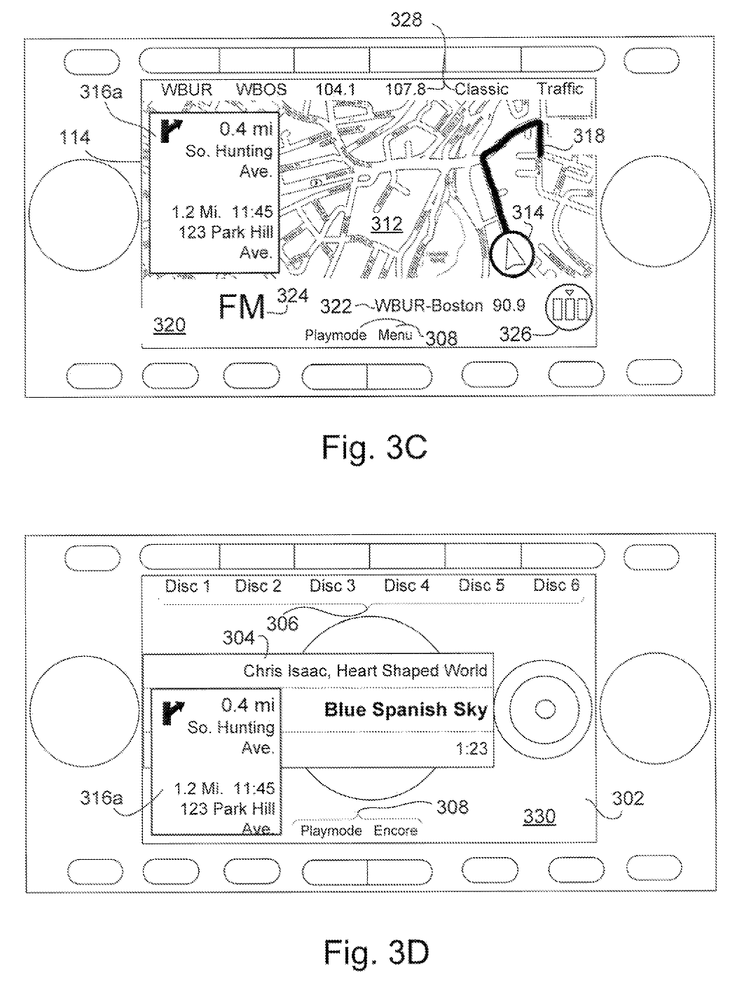

FIGS. 3A-3D are user interfaces of a vehicle entertainment system.

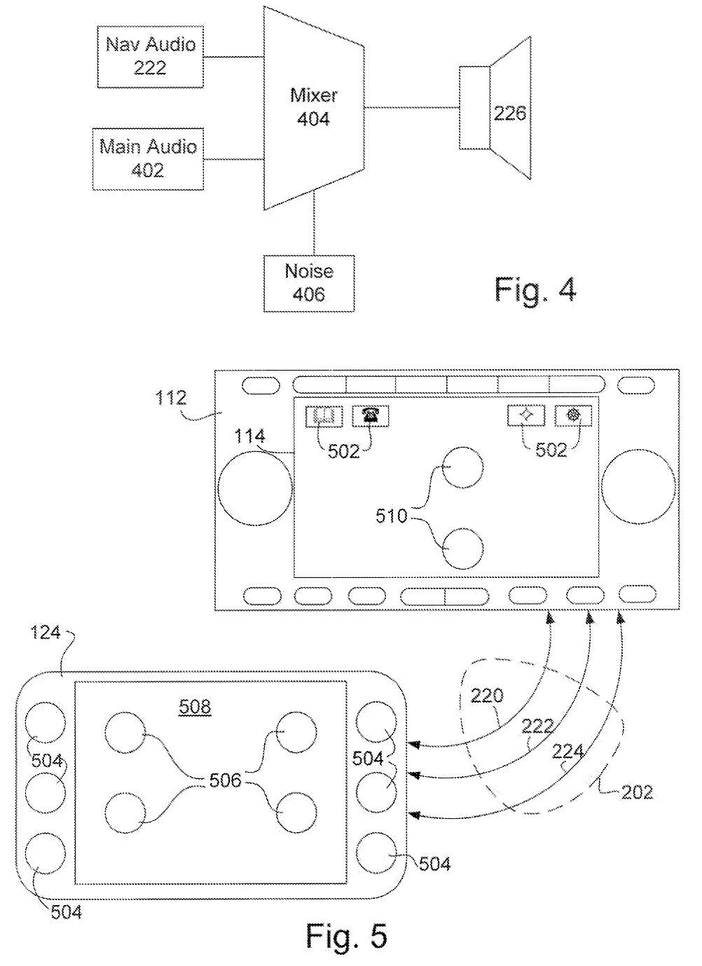

FIG. 4 is a block diagram of an audio mixing circuit.

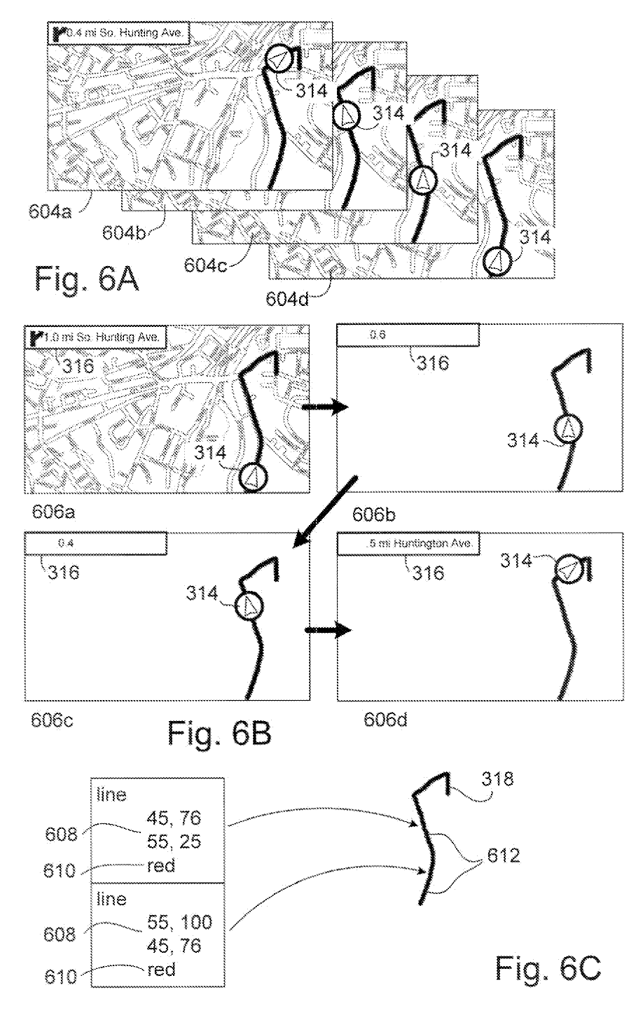

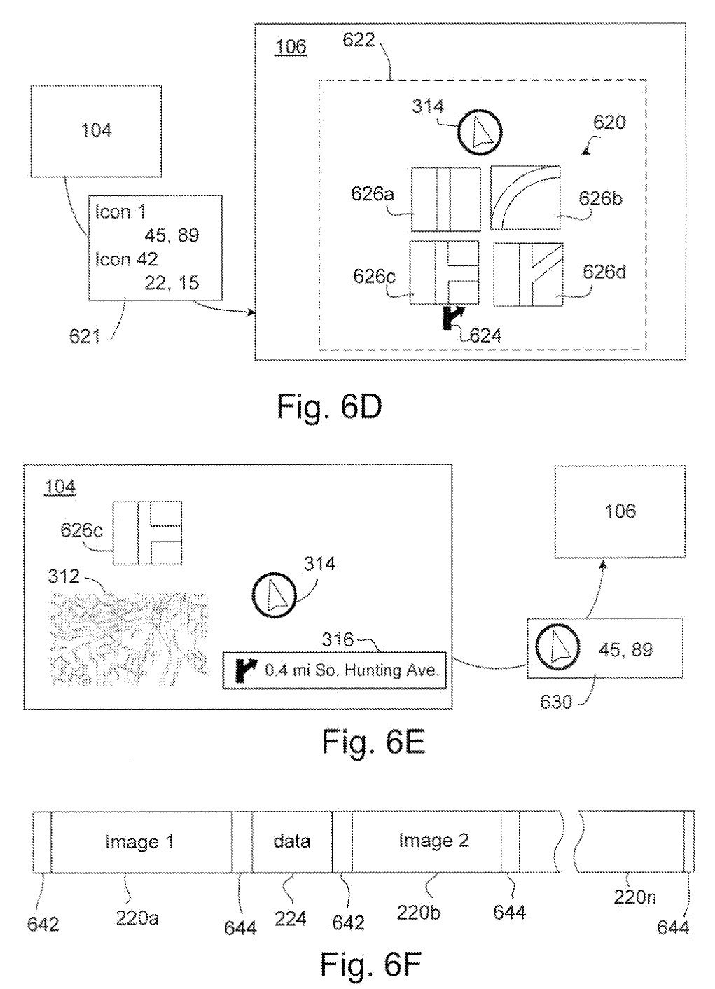

FIGS. 6A-6F are schematic diagrams of processes to update a user interface.

In-vehicle entertainment systems and portable navigation systems each have unique features that the other generally lacks. One or the other or both can be improved by using capabilities provided by the other. For example, a portable navigation system may have an integrated antenna, which may provide a weaker signal than an external antenna mounted on a roof of a vehicle to be used by the vehicle's entertainment system. In vehicle entertainment systems may lack navigation capabilities or have only limited capabilities. When we refer to a navigation system in this disclosure, we are referring to a portable navigation system separate from any vehicle navigation system that may be built-in to a vehicle. A communications system that can link a portable navigation system with an in-vehicle entertainment system can allow either system to provide services to or receive services shared by the other device.

An in-vehicle entertainment system 102 and a portable navigation system 104 may be linked within a vehicle 100 as shown in FIG. 1A. In some examples, the entertainment system 102 includes a head unit 106, media sources 108, and communications interfaces 110. The navigation system 104 is connected to one or more components of the entertainment system 102 through a wired or wireless connection 101. The media sources 108 and communications interfaces 110 may be integrated into the head unit 106 or may be implemented separately. The communications interfaces may include radio receivers 110a for FM, AM, or satellite radio signals, a cellular interface 110b for two-way communication of voice or data signals, a wireless interface 110c for communicating with other electronic devices such as wireless phones or media players 111, and a vehicle communications interface 110d for receiving data from the vehicle 100. The interface 110c may use, for example, Bluetooth®, WiFi®, or WiMax® wireless technology. References to Bluetooth in the remainder of this description should be taken to refer to Bluetooth or to any other wireless technology or combination of technologies for communication between devices. The communications interfaces 110 may be connected to at least one antenna 113. The head unit 106 also has a user interface 112, which may be a combination of a graphics display screen 114, a touch screen sensor 116, and physical knobs and switches 118, and may include a processor 120 and software 122.

In some examples, the navigation system 104 includes a user interface 124, navigation data 126, a processor 128, navigation software 130, and communications interfaces 132. The communications interface may include GPS, for finding the system's location based on GPS signals from satellites or terrestrial beacons, a cellular interface for transmitting voice or data signals, and a Bluetooth interface for communicating with other electronic devices, such as wireless phones.

In some examples, the various components of the head unit 106 are connected as shown in FIG. 1B. An audio switch 140 receives audio inputs from various sources, including the radio tuner 110a, media sources such as a CD player 108a and an auxiliary input 108b, which may have a jack 142 for receiving input from an external source. The audio switch 140 also receives audio input from the navigation system 104 (not shown) through a connector 160. The audio switch sends a selected audio source to a volume controller 144, which in turn sends the audio to a power amplifier 146 and a loudspeaker 226. Although only one loudspeaker 226 is shown, the vehicle 100 typically has several. In some examples, audio from different sources may be directed to different loudspeakers, e.g., navigation prompts may be sent only to the loudspeaker nearest the driver while an entertainment program continues playing on other loudspeakers. The audio switch 140 and the volume controller 144 are both controlled by the processor 120. The processor receives inputs from the touch screen 116 and buttons 118 and outputs information to the display screen 114, which together form the user interface 112. In some examples, some parts of the interface 112 are physically separate from the other components of the head unit 106.

The processor may receive inputs from individual devices, such as a gyroscope 148 and backup camera 149, and exchanges information with a gateway 150 to an information bus 152 and direct signal inputs from a variety of sources 155, such as vehicle speed sensors or the ignition switch. Whether particular inputs are direct signals or are communicated over the bus 152 will depend on the architecture of the vehicle 100. In some examples, the vehicle is equipped with at least one bus for communicating vehicle operating data between various modules. There may be an additional bus for entertainment system data. The head unit 106 may have access to one or more of these busses. In some examples, a gateway module in the vehicle (not shown) converts data from a bus not available to the head unit 106 to a bus protocol that is available to the head unit 106. In some examples, the head unit 106 is connected to more than one bus and performs the conversion function for other modules in the vehicle. The processor may also exchange data with a wireless interface 159. This can provide connections to media players or wireless telephones, for example. The head unit 106 may also have a wireless telephone interface 110b built-in. Any of the components shown as part of the head unit 106 in FIG. 1B may be integrated into a single unit or may be distributed in one or more separate units. The head unit 106 may use the gyroscope 148 to sense speed, acceleration and rotation (e.g., turning) rather than, or in addition to, receiving such information from the vehicle's sensors. Any of the inputs shown connected to the processor may also be passed on directly to the connector 160, as shown for the backup camera 149.

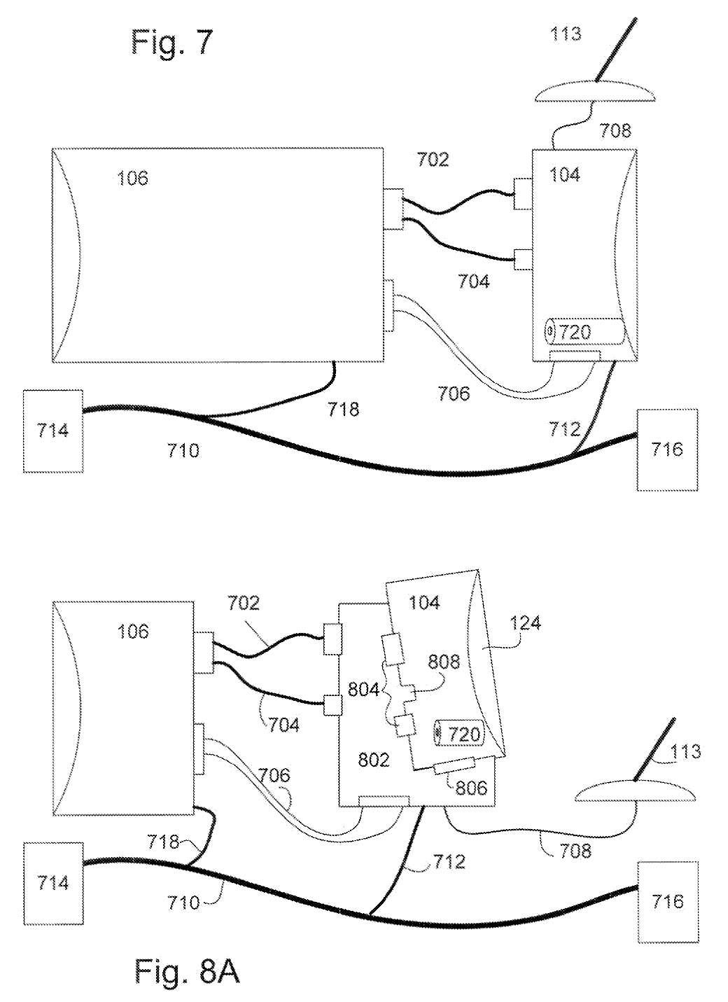

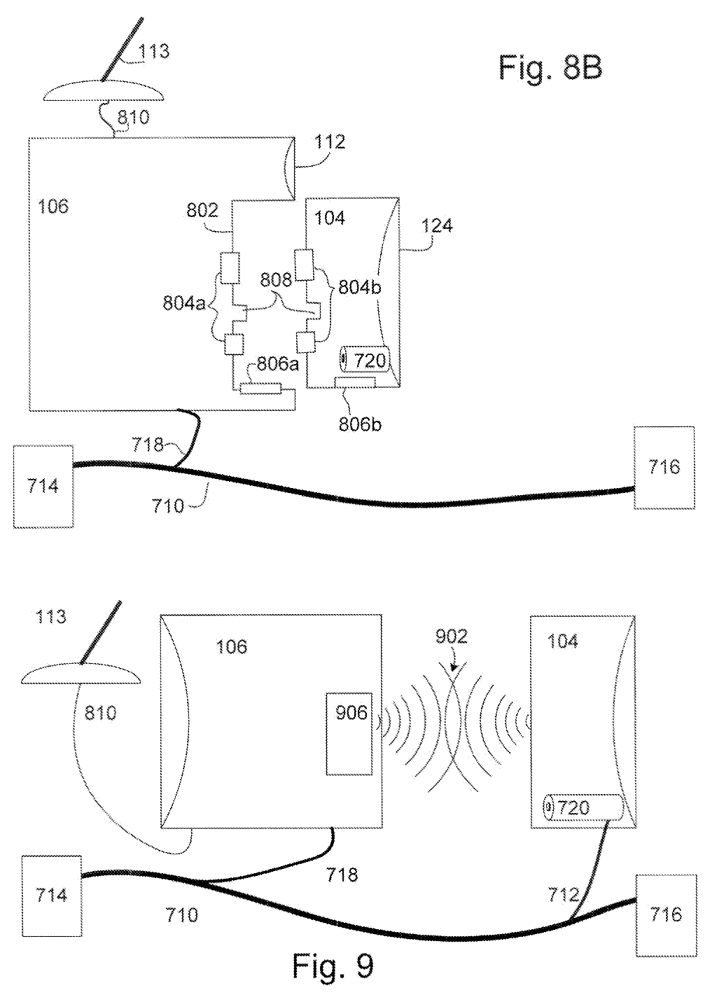

As noted above, in some examples, the connection to the navigation system 104 is wireless, thus the arrows to and from the connector 160 in FIG. 1B would run instead to and from the wireless interface 159. In wired examples, the connector 160 may be a set of standard cable connectors, a customized connector for the navigation system 104 or a combination of connectors, as discussed with regard to FIGS. 7 and 8A, below.

In some examples, the various components of the navigation system 104 are connected as shown in FIG. 1C. The processor 128 receives inputs from communications interfaces including a wireless interface (such as a Bluetooth interface) 132a and a GPS interface 132b, each with its own antenna 134 or a shared common antenna. The wireless interface 132a and GPS interface 132b may include connections 135 for external antennas or the antennas 134 may be internal to the navigation system 104. The processor 128 also may also transmit and receive data through a connector 162, which mates to the connector 160 of the head unit 106 (in some examples with cables in between, as discussed below). Any of the data communicated between the navigation system 104 and the entertainment system 102 may be communicated though either the connector 162, the wireless interface 132a, or both. An internal speaker 168 and microphone 170 are connected to the processor 128. The speaker 168 may be used to output audible navigation instructions, and the microphone 170 may be used for voice recognition. The speaker 168 may also be used to output audio from a wireless connection to a wireless phone using wireless interface 132a. The microphone 170 may also be used to pass to a wireless phone using wireless interface 132a. Audio input and output may also be provided by the entertainment system 102. The audio signals may connect directly through the connector 162 or may pass through the processor 128. The navigation system 104 includes a storage 164 for map data 126, which may be, for example, a hard disk, an optical disc drive or flash memory. This storage 164 may also include recorded voice data to be used in providing the audible instructions output to speaker 168. Software 130 may also be in the storage 164 or may be stored in a dedicated memory.

The connector 162 may be a set of standard cable connectors, a customized connector for the navigation system 104 or a combination of connectors, as discussed with regard to FIGS. 7 and 8A, below.

A graphics processor (GPU) 172 may be used to generate images for display through the user interface 124 or through the entertainment system 102. The GPU 172 may receive video images from the entertainment system 102 directly through the connector 162 or through the processor 128 and process these for display on the navigation system's user interface 124. Alternatively, video processing could be handled by the main processor 128, and the images may be output through the connector 162 either by the processor 128 or directly by the GPU 172. The processor 128 may also include digital/analog converters (DACs and ADCs) 166, or these functions may be performed by dedicated devices. The user interface 124 may include an LCD or other video display screen 174, a touch screen sensor 176, and controls 178. In some examples, video signals, such as from the backup camera 149, are passed directly to the display 174. A power supply 180 regulates power received from an external source 182 or from an internal battery 720. The power supply 180 may also charge the battery 720 from the external source 182.

In some examples, as shown in FIG. 2, the navigation system 104 can use signals available through the entertainment system 102 to improve the operation of its navigation function. The external antenna 113 on the vehicle 100 may provide a better GPS signal 204a than one integrated into the navigation system 104. Such an antenna 113 may be connected directly to the navigation system 104, as discussed below, or the entertainment system 102 may relay the signals 204a from the antenna after tuning them itself with a tuner 205 to create a new signal 204b. In some examples, the entertainment system 102 may use its own processor 120 in the head unit 106 or elsewhere to interpret signals 204a received by the antenna 113 or signals 204b received from the tuner 205 and relay longitude and latitude data 206 to the navigation system 102. This may also be used when the navigation system 104 requires some amount of time to determine a location from GPS signals after it is activated—the entertainment system 102 may provide a current location to the navigation system 104 as soon as the navigation system 104 is turned on or connected to the vehicle, allowing it to begin providing navigation services without waiting to determine the vehicle's location for itself. Because it is connected to the vehicle 100 through a communications interface 110d (shown connected to a vehicle information module 207), the entertainment system 102 may also be able to provide the navigation system 104 with data 203 not otherwise available to the navigation system 104, such as vehicle speed 208, acceleration 210, steering inputs 212, and events such as braking 214, airbag deployment 216, or engagement 218 of other safety systems such as traction control, roll-over control, tire pressure monitoring, and anything else that is communicated over the vehicle's communications networks.

The navigation system 104 can use the data 203 for improving its calculation of the vehicle's location, for example, by combining the vehicle's own speed readings 208 with those derived from GPS signals 204a, 204b, or 206, the navigation system 104 can make a more accurate determination of the vehicle's true speed. Signal 206 may also include gyroscope information that has been processed by processor 120 as mentioned above. If a GPS signal 204a, 204b, or 206 is not available, for example, if the vehicle 100 is surrounded by tall buildings or in a tunnel and does not have a line of sight to enough satellites, the speed 208, acceleration 210, steering 212, and other inputs 214 or 218 characterizing the vehicle's motion can be used to estimate the vehicle's course by dead reckoning. Gyroscope information that has been processed by processor 120 and is provided by 206 may also be used. In some examples, the computations of the vehicle's location based on information other than GPS signals may be performed by the processor 120 and relayed to the navigation system in the form of a longitude and latitude location. If the vehicle has its own built-in navigation system, such calculations of vehicle location may also be used by that system. Other data 218 from the entertainment system of use to the navigation system may include traffic data received through the radio or wireless phone interface, collision data, and vehicle status such as doors opening or closing, engine start, headlights or internal lights turned on, and audio volume. This can be used for such things as changing the display of the navigation device to compensate for ambient light, locking-down the user interface during while driving, or calling for emergency services in the event of an accident if the car does not have its own wireless phone interface.

The navigation system 104 may also provide services through the entertainment system 102 by exchanging data including video signals 220, audio signals 222, and commands or information 224, collectively referred to as data 202. Power for the navigation system 104, for charging or regular use, may be provided from the entertainment system's power supply 156 to the navigation system's power supply 180 through connection 225. If the navigation system's communications interfaces 132 include a wireless phone interface 132a and the entertainment system 102 does not have one, the navigation system 104 may enable the entertainment system 102 to provide hands-free calling to the driver through the vehicle's speakers 226 and a microphone 230. The audio signals 222 carry the voice from the driver to the wireless phone interface 132a in the navigation system and carry any audio from a call back to the entertainment system 202. The audio signals 222 can also be used to transfer audible instructions such as driving directions or voice recognition acknowledgements from the navigation system 104 to the head unit 106 for playback on the vehicle's speakers 226 instead of using a built-in speaker 168 in the navigation system 104.

The audio signals 222 may also be used to provide hands-free operation from one device to another. If the entertainment system 102 has a hands-free system 232, it may receive voice inputs and relay them as audio signals 222 to the navigation system 104 for interpretation by voice recognition software and receive audio responses 222, command data and display information 224, and updated graphics 220 back from the navigation system 104. The entertainment system 102 may also interpret the voice inputs itself and send control commands 224 directly to the navigation system 204. If the navigation system 104 has a hands-free system 236 capable of controlling aspects of the entertainment system, the entertainment system may receive audio signals from its own microphone 230, relay them as audio signals 222 to the navigation system 104 for interpretation, and receive control commands 224 and audio responses 222 back from the navigation system 104. In some examples, the navigation system 104 also functions as a personal media player, and the audio signals 222 may carry a primary audio program to be played back through the vehicle's speakers 226.

If the head unit 106 has a better screen 114 than the navigation system 104 has (for example, it may be larger, brighter, or located where the driver can see it more easily), video signals 220 can allow the navigation system 104 to display its user interface 124 through the head unit 106's screen 114. The head unit 106 can receive inputs on its user interface 116 or 118 and relay these to the navigation system 104 as commands 224. In this way, the driver only needs to interact with one device, and connecting the navigation system 104 to the entertainment system 102 allows the entertainment system 102 to operate as if it included navigation features. In some examples, the navigation system 104 may be used to display images from the entertainment system 102, for example, from the backup camera 149 or in place of using the head unit's own screen 114. Such images can be passed to the navigation system 104 using the video signals 220. This has the advantage of providing a graphical display screen for a head unit 106 that may have a more-limited display 114. For example, images from the backup camera 149 may be relayed to the navigation system 104 using video signals 220, and when the vehicle is put in to reverse, as indicated by a direct input 154 or over the vehicle bus 152 (FIG. 1B), this can be communicated to the navigation system 104 using the command and information link 224. At this point, the navigation system 104 can automatically display the backup camera's images. This can be advantageous when the navigation system 104 has a better or move-visible screen 174 than the head unit 106 has, giving the driver the best possible view.

In cases where the entertainment system 102 does include navigation features, the navigation system 104 may be able to supplement or improve on those features, for example, by providing more-detailed or more-current maps though the command and information link 224 or offering better navigation software or a more powerful processor. In some examples, the head unit 106 may be equipped to transmit navigation service requests over the command and information link 224 and receive responses from the navigation system's processor 128. In some examples, the navigation system 104 can supply software 130 and data 126 to the head unit 106 to use with its own processor 120. In some examples, the entertainment system 102 may download additional software to the personal navigation system, for example, to update its ability to calculate location based on the specific information that vehicle makes available.

The ability to relay the navigation system's interfaces through the entertainment system has the benefit of allowing the navigation system 104 to be located somewhere not readily visible to the driver and to still provide navigation and other services. The connections described may be made using a standardized communications interface or may be proprietary. A standardized interface may allow navigation systems from various manufacturers to work in a vehicle without requiring customization. If the navigation systems use proprietary formats for data, signals, or connections, the entertainment system 102 may include software or hardware that allows it to convert between formats as required.

In some examples, the navigation system's interface 124 is relayed through the head unit's interface 112 as shown in FIGS. 3A-3D. In this example, the user interface 112 includes a screen 114 surrounded by buttons and knobs 118a-118s. Initially, as shown in FIG. 3A, the screen 114 shows an image 302 unrelated to navigation, such as an identification 304 and status 305 of a song currently playing on the CD player 108a. Other information 306 indicates what data is on CDs selectable by pressing buttons 118b-118h and other functions 308 available through buttons 118n and 118o. Pressing a navigation button 118m causes the screen 114 to show an image 310 generated by the navigation system 104, as shown in FIG. 3B. This image includes a map 312, the vehicle's current location 314, the next step of directions 316, and a line 318 showing the intended path. This image 310 may be generated completely by the navigation system 104 or by the head unit 106 as instructed by the navigation system 104, or a combination of the two. Each of these methods is discussed below.

In the example of FIG. 3C, a screen 320 combines elements of the navigation screen 310 with elements related to other functions of the entertainment system 102. In this example, an indication 322 of what station is being played, the radio band 324, and an icon 326 indicating the current radio mode use the bottom of the screen, together with function indicators 308 and other radio stations 328 displayed at the top, with the map 312, location indicator 314, a modified version 316a of the directions, and path 318 in the middle. The directions 316a may also include point of interest information, such as nearby gas stations or restaurants, the vehicle's latitude and longitude, current street name, distance to final destination, time to final destination, and subsequent or upcoming driving instructions such as “in 0.4 miles, turn right onto So. Hunting Ave.”

In the example of FIG. 3D, a screen image 330 includes the image 302 for the radio with the next portion of the driving directions 316 from the navigation system overlaid, for example, in one corner. Such a screen may be displayed, for example, if the user wishes to adjust the radio while continuing to receive directions from the navigation system 104, to avoid missing a turn. Once the user has selected a station, the screen may return to the screen 320 primarily showing the map 312 and directions 316.

Audio from the navigation system 104 and entertainment system 102 may similarly be combined, as shown in FIG. 4. The navigation system may generate occasional audio signals, such as a voice prompts telling the driver about an upcoming turn, which are communicated to the entertainment system 102 through audio signals 222 as described above. At the same time, while the entertainment system 102 is likely to generate continuous audio signals 402, such as music from the radio or a CD. In some examples, a mixer 404 in the head unit 106 determines which audio source should take priority and directs that one to speakers 226. For example, when a turn is coming up and the navigation system 104 sends an announcement over audio signals 222, the mixer may reduce the volume of music and play the turn instructions at a relatively loud volume. If the entertainment system is receiving vehicle information 203, it may also base the volume on factors 406 that may cause ambient noise, e.g., increasing the volume to overcome road noise based on the vehicle speed 208. In some examples, the entertainment system may include a microphone to directly discover noise levels 406 and compensate for them either by raising the volume or by actively canceling the noise. The audio from the lower-priority source may be silenced completely or may only be reduced in volume and mixed with the louder high-priority audio. The mixer 404 may be an actual hardware component or may be a function carried out by the processor 120.

When the head unit's interface 112 is used in this manner as a proxy for the navigation system's interface 124, in addition to using the screen 114, it may also use the head unit's inputs 118 or touch screen 116 to control the navigation system 104. In some examples, as shown in FIGS. 3A-3D, some buttons on the head unit 106 may not have dedicated functions, but instead have context-sensitive functions that are indicated on the screen 114. Such buttons or knobs 118i and 118s can be used to control the navigation system 104 by displaying relevant features 502 on the screen 114, as shown in FIG. 5. These might correspond to physical buttons 504 on the navigation system 104 or they might correspond to controls 506 on a touch-screen 508. If the head unit's interface 112 includes a touch screen 116, it could simply be mapped directly to the touch screen 506 of the navigation system 104 or it could display virtual buttons 510 that correspond to the physical buttons 504. The amount and types of controls displayed on the screen 114 may be determined by the specific data sent from the navigation system 104 to the entertainment system 102. For example, if point of information data is sent, then one of the virtual buttons 510 may represent the nearest point of information, and if the user selects it, additional information may be displayed.

Several methods can be used to generate the screen images shown on the screen 114 of the head unit 106. In some examples, as shown in FIGS. 6A-6C, a video image 602 is transmitted from the navigation system 104 to the head unit 106. This image 602 could be transmitted as a data file using an image format like BMP, JPEG or PNG or it may be streamed as an image signal over a connection such as DVI or Firewire or analog alternatives like RBG. The head unit 106 may decode the signal 604 and deliver it directly to the screen 114 or it may filter it, for example, upscaling, downscaling, or cropping to accommodate the resolution of the screen 114. The head unit may combine part of or the complete image 602 with screen image elements generated by the head unit itself or other accessory devices to generate mixed images like those shown in FIGS. 3C and 3D.

The image may be provided by the navigation system in several forms including a full image map, difference data, or vector data. For a full image map, as shown in FIG. 6A, each frame 604a-604d of image data contains a complete image. For difference data, as shown in FIG. 6B, a first frame 606a includes a complete image, and subsequent frames 606b-606d only indicate changes to the first frame 606a (note moving indicator 314 and changing directions 316). Vector data, as shown in FIG. 6C, provides a set of instructions that tell the processor 120 how to draw the image, e.g., instead of a set of points to draw the line 318, vector data includes an identification 608 of the end points of segments 612 of the line 318 and an instruction 610 to draw a line between them.

The image may also be transmitted as icon data, as shown in FIG. 6D, in which the head unit 106 maintains a library 622 of images 620 and the navigation system 104 provides instructions of which images to combine to form the desired display image. Storing the images 620 in the head unit 106 allows the navigation system 104 to simply specify 621 which elements to display. This can allow the navigation system 104 to communicate the images it wishes the head unit 106 to display using less bandwidth than may be required for a full video image 602. Storing the images 620 in the head unit 106 may also allow the maker of the head unit to dictate the appearance of the display, for example, maintaining a branded look-and-feel different from that used by the navigation system 104 on its own interface 124. The pre-arranged image elements 620 may include icons like the vehicle location icon 314, driving direction symbols 624, or standard map elements 626 such as straight road segments 626a, curves 626b, and intersections 626c, 626d. Using such a library of image elements may require some coordination between the maker of the navigation system 104 and the maker of the head unit 106 in the case where the manufacturers are different, but could be standardized to allow interoperability. Such a technique may also be used with the audio navigation prompts discussed above—pre-recorded messages such as “turn left in 100 yards” may be stored in the head unit 106 and selected for playback by the navigation system 104.

In a similar fashion, as shown in FIG. 6E, the individual screen elements 620 may be transmitted from the navigation system 104 with instructions 630 on how they may be combined. In this case, the elements may include specific versions such as actual maps 312 and specific directions 316, such as street names and distance indications, that would be less likely to be stored in a standardized library 622 in the head unit 106. Either approach may simplify generating mixed-mode screen images like screen images 320 and 330, because the head unit 106 does not have to analyze a full image 602 to determine which portion to display.

When an image is being transmitted from the navigation system 104 to the head unit 106, the amount of bandwidth required may dominate the connections between the devices. For example, if a single USB connection is used for the video signals 220, audio signals 222, and commands and information 224, a full video stream may not leave any room for control data. In some examples, as shown in FIG. 6F, this can be addressed by dividing the video signals 220 into blocks 220a, 220b, . . . 220n and interleaving blocks of commands and information 224 in between them. This can allow high priority data like control inputs to generate interrupts that assure they get through. Special headers 642 and footers 644 may be added to the video blocks 220a-220n to indicate the start or end of frames, sequences of frames, or full transmissions. Other approaches may also be used to transmit simultaneous video, audio, and data, depending on the medium used.

In some examples, the navigation system 104 may be connected to the entertainment system 102 through a direct wire connection as shown in FIG. 7, by a docking unit, as shown in FIGS. 8A and 8B, or wirelessly, as shown in FIG. 9.

In the example of FIG. 7, one or more cables 702, 704, 706, 708 connect the navigation system 104 to the head unit 106 and other components of the entertainment system 102. The cables may connect the navigation system 104 to multiple sources, for example, they may include a direct connection 708 to the external antenna 113 and a data connection 706 to the head unit 106. In some examples, the navigation system 104 may be connected only to the head unit 106, which relays any needed signals from other interfaces such as the antenna 113.

For the features discussed above, the cables 702, 704, and 706 may carry video signals 220, audio signals 222, and commands or information 224 (FIG. 5) between the navigation system 104 and the head unit 106. The video signals 220 may include entire screen images or components, as discussed above. In some examples, dedicated cables, e.g., 702 and 704, are used for video signals 220 and audio signals 222 while a data cable, e.g., 706, is used for commands and information 224. The video connection 702 may be made using video-specific connections such as analog composite or component video or digital video such as DVI or LVDS. The audio connections 704 may be made using analog connections such as mono or stereo, single-ended or differential signals, or digital connections such as PCM, I2S, and coaxial or optical SPDIF. In some examples, the data cable 706 supplies all of the video signals 220, audio signals 222, and commands and information 224. The navigation system 104 may also be connected directly to the vehicle's information and power distribution bus 710 through at least one break-out connection 712. This connection 712 may carry vehicle information such as speed, direction, illumination settings, acceleration and other vehicle dynamics information from other electronics 714, raw or decoded GPS signals if the antenna 113 is connected elsewhere in the vehicle, and power from the vehicle's power supply 716. As noted above, there may be more than one data bus, and an individual device, such as the navigation system 104, may be connected to one or more than one of them, and may receive data signals directly from their sources rather than over one of the busses. Power may be used to operate the navigation system 104 and to charge a battery 720. In some examples, the battery 720 can power the navigation system 104 without any external power connection. A similar connection 718 carries such information and power to the head unit 106.

The data connections 706 and 712 may be a multi-purpose format such as USB, Firewire, UART, RS-232, RS-485, I2C, or an in-vehicle communication network such as controller area network (CAN), or they could be custom connections devised by the maker of the head unit 106, navigation system 104, or vehicle 100. The head unit 106 may serve as a gateway for the multiple data formats and connection types used in a vehicle, so that the navigation system 104 needs to support only one data format and connection type. Physical connections may also include power for the navigation system 104.

As shown in FIG. 8A, a docking 802 unit may be used to make physical connections between the navigation system 104 and the entertainment system 102. The same power, data, signal, and antenna connections 702, 704, 706, and 708 as described above may be made through the docking unit 802 through cable connectors 804 or through a customized connector 806 that allows the various different physical connections that might be needed to be made through a single connector. An advantage of a docking unit 802 is that it may provide a more stable connection for sensitive signals such as from the GPS antenna 113.

The docking unit 802 may also include features 808 for physically connecting to the navigation system 104 and holding it in place. This may function to maintain the data connections 804 or 806, and may also serve to position the navigation system 104 in a given position so that its interface 124 an be easily seen and used by the driver of the car.

In some examples, as shown in FIG. 8B, the docking unit 802 is integrated into the head unit 106, and the navigation system's interface 124 serves as part or all of the head unit's interface 112. (The navigation system 104 is shown removed from the dock 802 in FIG. 8B; the connectors 804 and 806 are shown split into dock-side connectors 804a and 806a and device-side connectors 804b and 806b.) This can eliminate the cables connecting the docking unit 802 to the head unit 106. In the example of FIG. 8B, the antenna 113 is shown with a connection 810 to the head unit 106. If the navigation system's interface 124 is being used as the primary interface, some of the signals described above as being communicated from the head unit 106 to the navigation system 104 are in fact communicated from the navigation system 104 to the head unit 106. For example, if the navigation system's interface 124 is the primary interface for the head unit 106, the connections 804 or 806 may need to communicate control signals from the navigation system 104 to the head unit 106 and may need to communicate video signals from the head unit 106 to the navigation system 104. The navigation system 104 can then be used to select audio sources and perform the other functions carried out by the head unit 106. In some examples, the head unit 106 has a first interface 112 and uses the navigation system 106 as a secondary interface. For example, the head unit 106 may have a simple interface for selecting audio sources and displaying the selection, but it will use the interface 124 of the navigation system 104 to display more detailed information about the selected source, such as the currently playing song, as in FIGS. 3A or 3D.

In some examples, a wireless connection 902 can be used to connect the navigation system 104 and the entertainment system 102, as shown in FIG. 9. Standard wireless data connections may be used, such as Bluetooth, WiFi, or WiMax. Proprietary connections could also be used. Each of the data signals 202 (FIG. 5) can be transmitted wirelessly, allowing the navigation system 104 to be located anywhere in the car and to make its connections to the entertainment system automatically. This may, for example, allow the user to leave the navigation system 104 in her purse or briefcase, or simply drop it on the seat or in the glove box, without having to make any physical connections. In some example, the navigation system is powered by the battery 720, but a power connection 712 may still be provided to charge the battery 720 or power the system 104 if the battery 720 is depleted.

The wireless connection 902 may be provided by a transponder within the head unit 106 or another component of the entertainment system 102, or it may be a stand-alone device connected to the other entertainment system components through a wired connection, such as through the data bus 710. In some examples, the head unit 106 includes a Bluetooth connection for connecting to a user's mobile telephone 906 and allowing hands-free calling over the audio system. Such a Bluetooth connection can be used to also connect the navigation system 106, if the software 122 in the head unit 106 is configured to make such connections. In some examples, to allow a wirelessly-connected navigation system 104 to use the vehicle's antenna 113 for improved GPS reception, the antenna 113 is connected to the head unit 106 with a wired connection 810, and GPS signals are interpreted in the head unit and computed longitude and latitude values are transmitted to the navigation system 104 using the wireless connection 902. In the example of Bluetooth, a number of Bluetooth profiles may be used to exchange information, including, for example, advanced audio distribution profile (A2DP) to supply audio information, video distribution profile (VDP) for screen images, hands-free, human interface device (HID), and audio/video remote control (AVRCP) profiles for control information, and serial port and object push profiles for exchanging navigation data, map graphics, and other signals.

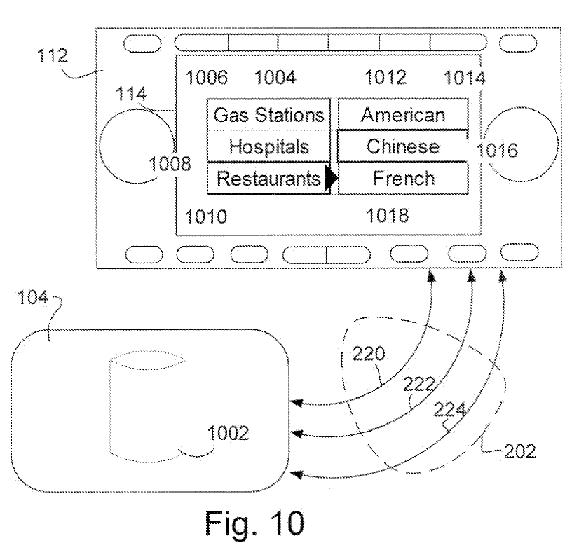

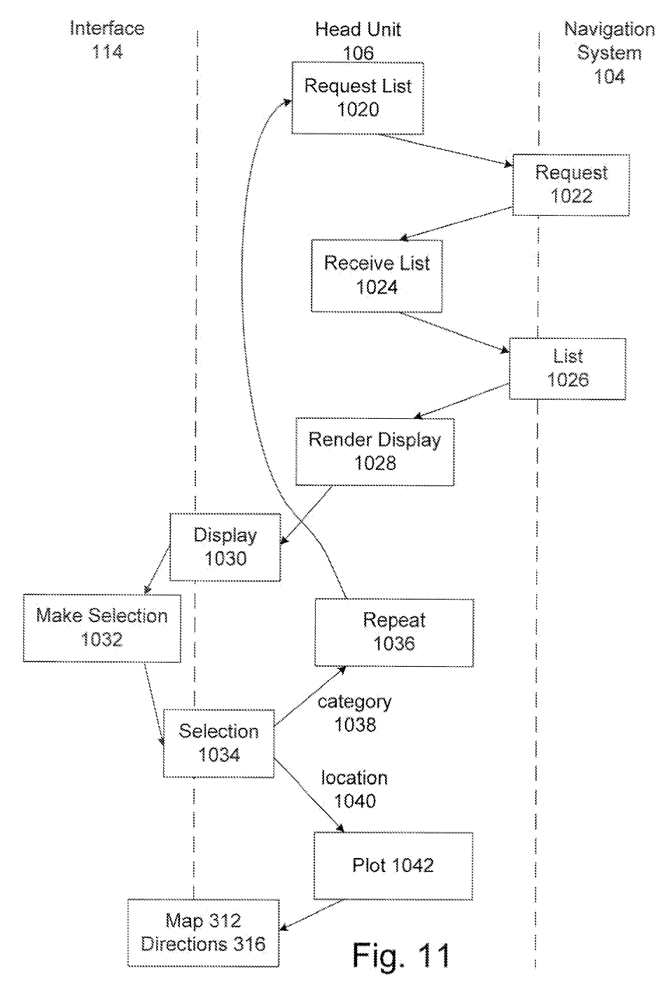

In some examples, as shown in FIGS. 10 and 11, the navigation system 104 may include a database 1002 of points of interest and other information relevant to navigation, and the user interface 112 of the head unit 106 may be used to interact with this database. For example, if a user wants to find all the Chinese restaurants near his current location, he uses the controls 118 on the head unit 106 to move through a menu 1004 of categories such as “gas stations” 1006, “hospitals” 1008, and “restaurants” 1010, selecting “restaurants” 1010. He then uses the controls 118 to select a type of restaurant, in this case, “Chinese” 1016, from a list 1012 of “American” 1014, “Chinese” 1016, and “French” 1018. Examples of a user interface for such a database are described in U.S. patent application Ser. No. 11/317,558, filed Dec. 22, 2005, which is incorporated here by reference.

This feature may be implemented using the process shown in FIG. 11. The head unit 106 queries the navigation system 104 by requesting 1020 a list of categories. This request 1022 may include requesting the categories, an index number and name for each, and the number of entries in each category. Upon receiving 1024 the requested list 1026, the head unit 106 renders 1028 a graphical display element and displays it 1030 on the display 114. This display may be generated using elements in the head unit's memory or may be provided by the navigation system 104 to the head unit 106 as described above. Once the user makes 1032 a selection 1034, the head unit either repeats 1036 the process of requesting 1020 a list 1026 for selected category 1038 or, if the user has selected a list item representing a location 1040, the head unit 106 plots 1042 that location 1040 on the map 312 and displays directions 316 to that location 1040. Similar processes may be used to allow the user to add, edit, and delete records in the database 1002 through the interfaced 112 of the head unit 106. Other interactions that the user may be able to have with the database 1002 include requesting data about a point of interest, such as the distance to it, requesting a list of available categories, requesting a list of available locations, or looking up an address based on the user's knowledge of some part of it, such as the house number, street name, city, zip code, state, or telephone number. The user may also be able to enter a specific address.

Other implementations are within the scope of the following claims and other claims to which the applicant may be entitled.

What is claimed is:

1. A method comprising
receiving current vehicle data generated by circuitry of a vehicle, and
using functions of a personal navigation device, which are otherwise used to process device navigational data that are generated by navigational circuitry in the personal navigation device, to process the current vehicle data to produce output navigational information.

2. The method of claim 1 in which the current vehicle data includes data generated from wireless signals about the vehicle's location and received from a remote source.

3. The method of claim 2 in which the current vehicle data about the vehicle's location has a relatively higher level of accuracy than the device navigational data.

4. The method of claim 1 in which the current vehicle data comprises location information generated by devices on the vehicle.

5. The method of claim 1 in which the current vehicle data comprises information characterizing motion of the vehicle.

6. The method of claim 1 in which the current vehicle data comprises data related to operation of the vehicle.

7. The method of claim 1 in which the current vehicle data comprises location information derived from information characterizing motion of the vehicle.

8. A method comprising
providing a display location associated with a media head unit of a vehicle at which information may be displayed to an occupant of the vehicle, and
generating a display at the display location based at least in part on navigational data or output navigational information provided by a personal navigation device.

9. The method of claim 8 in which the display location comprises a place on the media head unit at which the personal navigation device can be mounted in an orientation that enables an occupant of the vehicle to view a display screen and manipulate controls of the personal navigation device.

10. The method of claim 8 in which the display location comprises a region of a display of the media head unit.

11. The method of claim 8 in which the personal navigation device is separate from the media head unit.

12. The method of claim 8 in which the display is generated based in part on navigational data or output navigational information provided by navigational circuitry of the vehicle.

13. The method of claim 8 in which the display is generated based in part on data or information unrelated to navigation.

14. The method of claim 8 in which the display is generated without direct user interaction with the personal navigation device.

15. A method comprising
generating a display at a display location associated with a media head unit of a vehicle based in part on data provided by a personal navigation device separate from the media head unit, and in part on data generated by the media head unit.

16. The method of claim 15 in which the data provided by the personal navigation device comprises a video image of a map.

17. The method of claim 15 in which the data provided by the personal navigation device comprises information describing a map.

18. The method of claim 15 in which the data provided by the personal navigation device comprises information usable by the media head unit to draw a map or display navigation directions based on images stored in a memory of the media head unit.

19. The method of claim 15 in which the data provided by the personal navigation device comprises information usable by the media head unit to display navigation status based on exchanged data.

20. The method of claim 15 in which the data generated by the media head unit comprises information about a status of a media playback component.

21. The method of claim 15 in which the data generated by the media head unit comprises information about a two-way wireless communication.

22. A method comprising
communicating user interface commands and navigational data between a personal navigation device and a media head unit of a vehicle, the user interface commands and navigational data being associated with a device user interface of the device, and
providing a vehicle navigation user interface at the media head unit,
the vehicle navigation user interface displaying navigational information and receiving user input to control the display of the navigational information on the media head unit,
the vehicle navigation user interface being coordinated with the user interface commands and navigational data associated with the device user interface.

23. A method comprising
providing a common communication interface between a media head unit of a vehicle and any one of several different brands of personal navigation device,
the common communication interface carrying user interface command information, audio-related signals for navigational prompts, image-related signals for navigational displays, point of interest data, database search commands, and navigational-related data identifying current locations of the vehicle in a common format, and
each of the different brands of personal navigation device internally using proprietary formats for at least some of the user interface command information, audio-related signals for navigational prompts, image-related signals for navigational displays, point of interest data, database search commands, and navigational-related data identifying current locations of the vehicle.

24. A personal navigation device comprising
navigational circuitry to generate device navigational data,
an input for vehicle data, and
a processor configured to process the device navigational data to perform navigational functions and output navigational information,
in which the processor is also configured to process the vehicle data to perform the navigational functions and output the navigational information.

25. The personal navigational device of claim 24 in which the input for vehicle data is configured to receive data generated from wireless signals about the vehicle's location received from a remote source.

26. The personal navigational device of claim 25 in which the input for vehicle data is configured to receive information generated by devices on the vehicle.

27. The personal navigational device of claim 25 in which the input for vehicle data is configured to receive information characterizing motion of the vehicle.

28. The personal navigational device of claim 25 in which the input for vehicle data is configured to receive data related to operation of the vehicle.

29. A personal navigation device comprising
a processor for generating images for display on a video display of navigational information, and
an output for providing the images to a separate device.

30. The personal navigational device of claim 29 in which the separate device is a media head unit of a vehicle.

31. An apparatus comprising
a media head unit of a vehicle,
a display location associated with the media head unit at which information may be displayed to an occupant of the vehicle,
the media head unit being configured to cause the display location to generate a display based at least in part on navigational data or output navigational information provided by a personal navigation device.

32. The apparatus of claim 31 in which the display location comprises a region of a display of the media head unit.

33. The apparatus of claim 31 in which the personal navigation device is separate from the media head unit.

34. The apparatus of claim 31 in which the media head unit is configured to generate the display based in part on navigational data or output navigational information provided by navigational circuitry of the vehicle.

35. The apparatus of claim 31 in which the media head unit is configured to generate the display based in part on data or information unrelated to navigation.

36. A media head unit for a vehicle configured to generate a graphical display based in part on data provided by a personal navigation device separate from the media head unit and in part on data generated by the media head unit.

37. The media head unit of claim 36 configured to generate the graphical display based in part on a video image of a map provided by the personal navigation device.

38. The media head unit of claim 36 configured to generate the graphical display based in part on information describing a map provided by the personal navigation device.

39. The media head unit of claim 36 also comprising a memory including images of map elements, the media head unit configured to generate the graphical display based in part on information provided by the personal navigation device and usable to draw a map based on the images in the memory of the media head unit.

40. The media head unit of claim 36 configured to generate the graphical display based in part information about a status of a media playback component.

41. The media head unit of claim 36 configured to generate the graphical display based in part information about a two-way wireless communication.

42. A system comprising
a personal navigation device, a media head unit of a vehicle, and a communications interface,
the communications interface to communicate user interface commands and navigational data associated with a device user interface of the personal navigation device between the personal navigation device and the media head unit,
the media head unit having a vehicle navigation user interface including a display of navigational information and an input for receiving user input for control of the display,
the vehicle navigation user interface being coordinated with the user interface commands and navigational data associated with the device user interface.

43. An apparatus comprising
a common communication interface between a media head unit of a vehicle and any one of several different brands of personal navigation device,
the common communication interface being configured to carry one or more of user interface command information, audio related signals for navigational prompts, image-related signals for navigational displays, point of interest data, and navigational-related data identifying current locations of the vehicle in a common format, and
configured to interface to the different brands of personal navigation devices using proprietary formats for at least some of the user interface command information, audio-related signals for navigational prompts, image-related signals for navigational displays, point of interest data, and navigational-related data identifying current locations of the vehicle.

44. A computer readable medium encoding instructions to cause a media head unit of a vehicle to
receive data from a personal navigation device representing a user interface of the personal navigation device,
generating a display for a user interface of the media head unit based on the received data,
receive input commands through the user interface of the media head unit, and
transmit the user interface commands to the personal navigation device.

45. The medium of claim 44 in which the instructions cause the media head unit to generate the display by combining graphical elements representing the user interface of the personal navigation device with graphical elements representing a status of components of the media head unit.

46. A computer readable medium encoding instructions to cause a personal navigation device having a user interface to
generate data representing a user interface of the device,
transmit the data to a media head unit of a vehicle,
receive input commands from the media head unit, and
apply the input commands to the user interface of the device as if the commands were received through the user interface of the device.

47. A computer readable medium encoding instructions to cause a personal navigation device having a user interface to
receive vehicle data from circuitry of a vehicle, and
process the vehicle data to produce output navigational information.

48. The medium of claim 47 in which the instructions cause the device to process the vehicle data to identify a speed of the vehicle.

49. The medium of claim 47 in which the instructions cause the device to process the vehicle data to identify a direction of the vehicle.

50. The medium of claim 47 in which the instructions cause the device to process the vehicle data to identify a location of the vehicle.

51. The medium of claim 47 in which the instructions cause the device to process the vehicle data to identify a location of the vehicle based on a previously-known location of the vehicle and a speed and direction of the vehicle since a time when the previously known location was determined.

52. A method comprising
at a media head unit of a vehicle, receiving an image from a backup camera associated with the vehicle and an indication that the vehicle is in a reverse gear,
transmitting the image and the indication to a personal navigation device having a video display screen,
at the personal navigation device, automatically displaying the image in response to receiving the indication.

53. The method of claim 52 in which the indication is the image.

54. A method comprising
at a media head unit of a vehicle,
requesting from a personal navigation device a list of information,
receiving the list of information,
displaying on a user interface a representation of the list of information,
receiving from the user interface a selection of an item of information from the list of information, and
requesting from the personal navigation device a second list of information related to the selected item.

55. The method of claim 54 also comprising, at the media head unit of a vehicle, instructing the personal navigation device to alter stored information related to the selected item of information.

56. The method of claim 55 in which altering stored information comprises one or more or a combination of adding, editing, or deleting information.
